(19) United States
(12) Patent Application Publication
(10) Pub. No.: US 2004/0244507 A1
(43) Pub. Date: Dec. 9, 2004

(54) Waste gas measuring device

(75) Inventor: Bernhard Benz, Aach (DE)

Correspondence Address: KUSNER & JAFFE, HIGHLAND PLACE SUITE 310, 6151 WILSON MILLS ROAD, HIGHLAND HEIGHTS, OH, 44143, US

(73) Assignee: M & C Products Analysentechnik GmbH

(21) Appl. No.: 10/853,085

(22) Filed: May 25, 2004

(30) Foreign Application Priority Data
Jun. 6, 2003 (DE) 103 25 702.0

(51) Int. Cl. C21B 11/10; G01N 1/00

(52) U.S. Cl. 73/864.81; 73/863.11

(57) ABSTRACT

The invention relates to a waste gas measuring device comprising a gas sampling device, a gas analysis device and at least one gas guiding member through which the waste gas can be guided along a gas path from the gas sampling device to the gas analysis device.

The invention relates to a waste gas measuring device comprising a gas sampling device, a gas analysis device and at least one gas guiding member through which the waste gas can be guided along a gas path from the gas sampling device to the gas analysis device.

Waste gases, especially waste gases from fossil fuel power stations and waste incineration plants, frequently contain fractions of mercury. The mercury can be present in the waste gas either in elemental form as Hg(O) or in the form of a chemical compound, especially for example in the form of HgCl₂.

As a result of its toxicity, there are legal limits for the fractions of mercury and mercury compounds in waste gases.

Accordingly, the fractions of mercury in waste gases must be continuously analysed and monitored.

In order to conduct suitable analyses, it is known to remove defined waste-gas fractions from the waste gas by means of a gas sampling device and pass this to a gas analysis device in which these waste gas fractions can be analysed.

However, as a result of the fractions of acidic constituents and sulphur oxides (HCl, SO₂, SO₃) regularly present in a waste gas, considerable problems arise with the method of measurement described hereinbefore.

This is because if gas analysis devices in which mercury is measured photometrically are used to determine the mercury, the fractions of sulphur oxides in the measured gas can overlap the absorption spectrum of the mercury which may result in incorrect measurements when determining the mercury fraction.

In addition, the sulphur oxides together with other constituents of the waste gas, especially if said gas goes below its dew-point temperature, can form acids which can damage the waste gas measuring device.

The object of the invention is to provide a waste gas measuring device through which negative effects, especially interference by sulphur oxides and acidic gas constituents present in the waste gas, on the measuring device can be prevented.

In order to solve this object, a waste gas measuring device having in its most general embodiment the following features is proposed:

a gas sampling device,

a gas analysis device and

at least one gas guiding member through which waste gas can be passed along a gas path from the gas sampling device to the gas analysis device, wherein

the gas path is passed through at least one aluminium oxide fill.

The invention is based on the following knowledge:

If the waste gas stream to be analysed is passed through an aluminium oxide fill before its analysis in the gas analysis device, the fractions of sulphur oxides present in the waste gas as well as the acidic gas fractions are adsorbed by the aluminium oxide so that after said passage of the waste gas through the aluminium oxide fill, these sulphur oxide fractions and acidic gas fractions can have no negative effects on the waste gas measuring device or the analysis of the waste gas.

Methods are known in which aluminium oxide can be used for drying of gases.

In the waste gas measuring device according to the invention, the aluminium oxide (Al₂O₃) is present in the form of a fill, that is as granular material. This granular material can have a high open porosity and thus a high specific surface area to enhance the adsorption of gas constituents to be adsorbed. The specific surface area of the aluminium oxide used can for example be between 250 and 450 m²/g, that is for example in a range between 300 and 400 m²/g or between 350 and 380 m²/g.

The density of the aluminium oxide can for example be less than 1 g/cm³, that is for example between 0.6 and 0.8 g/cm³ or between 0.65 and 0.75 g/cm³.

Of particular importance also is the grain size distribution of the aluminium oxide used for the fill: if too fine aluminium oxide were used (diameter less than 0.5 mm for example), the gas could no longer be passed through the fill since the fill would be too dense; if too coarse aluminium oxide were used (diameter greater than 10 mm for example), the reaction surface area would be too small so that no adequate degree of adsorption would be achieved. According to the application, the grain size distribution (diameter of the aluminium oxide granular material) can for example lie in the range between 0.5 and 10 mm, that is for example in the range between 0.5 and 8 mm or between 2 and 8 mm.

So-called “activated aluminium” has proved to be particularly suitable for the requirements in the waste gas measuring device according to the invention.

According to an embodiment according to the invention, a heating device by which the gas to be passed through the aluminium oxide fill can be heated is assigned to at least one aluminium oxide fill. In particular, the heating device can be designed such that the gas to be passed through the aluminium oxide fill can be heated by said device to a temperature above the dew-point temperature of the gas. By so heating the gas passed through the aluminium oxide fill, it can be prevented that the waste gas, or any of the gases of which the waste gas is composed, falls below its dew point in the area of the aluminium oxide fill. If the waste gas, if it were not heated, were to fall below its dew point at any point in the waste gas measuring device, especially for example in the area of the aluminium oxide fill, condensation liquid would form there. However, if any of the waste gas constituents to be analysed were to be bound in the condensation liquid, this would necessarily result in falsification of the waste gas analysis in the gas analysis device. Furthermore, as condensation liquid, acids could also form which could damage components of the waste gas measuring device.

Said disadvantages can consequently be prevented by the heating device according to the invention. The heating device can for example be arranged directly in the area of the aluminium oxide fill, but cumulatively or alternatively for example also in the area of the gas guiding members arranged between the gas sampling device and the aluminium oxide fill or for example also in the area of the gas sampling device or in the gas sampling device itself.

The heating device can for example be designed such that the gas to be passed through the aluminium oxide fill can be heated by said device to a temperature above 90° C., thus for example as well above 140° or above 160°. In this case, the heating device can be designed such that the gas to be passed through the aluminium oxide fill can be heated by said device to a temperature in a temperature range between 90° C. and 320° C., that is for example, also in a temperature range between 140° C. and 220° C.

In order to prevent the waste gas from falling below its dew point in any area of the waste gas measuring device, in addition to any heating device which may be assigned to the aluminium oxide fill, one or a plurality of heating devices described hereinbefore can be assigned to the waste gas measuring device so that it is ensured that the waste gas does not fall below its dew point in any area of the waste gas measuring device.

Alternatively or cumulatively to the aforesaid heating devices, the waste gas measuring device according to the application can be provided with one or a plurality of gas coolers. The waste gas can be cooled by this gas coolers and can thus be adjusted to a defined (lowered) dew-point temperature of the waste gas. For example, it can be provided that the waste gas is cooled such that its dew-point temperature is so low that the waste gas does not fall below its dew-point temperature on its gas path lying after the gas cooler in terms of flow. For example, it can be provided to cool the waste gas by the gas cooler to a dew-point temperature below 10° C., for example to a dew-point temperature between 1° C. and 10° C., that is for example as well to a dew-point temperature between 2° C. and. 8° C. or between 3° C. or 7° C.

The gas cooler can basically be arranged at any point on the gas path. According to one embodiment, it is provided that the gas cooler is arranged directly after the gas sampling device in terms of flow whereby the dew-point temperature is reduced to a defined value over the entire gas path. According to another embodiment, it is provided that the gas cooler is arranged directly before the gas analysis device in terms of flow whereby the dew-point temperature is reduced to a defined value in the gas analysis device.

By using one or a plurality of said gas coolers, it is possible to dispense with said heating devices.

The aluminium oxide fill can be located in a gas-tight body which is connected to the gas guiding members via at least one gas inlet and at least one gas outlet.

This body can, for example, be made of metal or a plastic casing or a combination thereof. Located in the body can be a retaining member on or in which the aluminium oxide fill is retained. This retaining member can, for example, be a screen, a perforated sheet, a filter or a combination thereof on which the aluminium oxide fill is piled or in which the aluminium oxide fill is arranged as in a “tea strainer”.

A waste gas, for example, a waste gas from a power station, can be fed into the waste gas measuring device by the gas sampling device.

A so-called “gas sampling probe” for example can be used as the gas sampling device. Such a gas sampling probe has a sampling tube which can be inserted in a waste gas. The waste gas can be taken up by the gas sampling device via the sampling tube and then fed into the waste gas measuring device. The sampling tube can be combined with a gas pre-filter. In order to prevent the waste gas in the gas sampling device from falling below the dew point, one of the heating devices described above can be assigned to said gas sampling device.

A gas, in this case a waste gas, can especially be analysed chemically and physically by the gas analysis device. The gas analysis device can especially comprise such a device with which the mercury and chlorine fractions of a gas can be analysed. For example, it can comprise a device with which the constituents of a gas can be measured spectrometrically.

By means of the gas guiding member(s), the waste gas taken up by the gas sampling device can be passed along the gas path from the gas sampling device to the gas analysis device.

The gas guiding members can for example be hoses or pipes through which a gas can be passed.

The mercury to be analysed in the waste gas by the gas analysis device is generally not present in the waste gas in elemental form, as Hg(O) but in the form of compounds, especially in the form of HgCl₂.

In order to be able to analyse this mercury bound to the chlorine in the waste gas, it is necessary to separate at least some of the HgCl₂ into its mercury and chlorine components before the analysis of the waste gas in the gas analysis device.

So-called converters are known for separating the chemical compounds present in a waste gas into their respective basic components. In these converters, usually in the presence of a suitable catalyst, chemical compounds are separated into their basic components. In order to accelerate the catalyst, it is also known to heat these catalysts.

For this purpose, the converter can be provided with a heating device by which the catalyst can be heated to a temperature between 350° C. and 800° C., that is for example to a temperature between 500° C. and 750° C. or between 600° C. and 700° C.

This separation can take place in the converter for example in the form of a pyrolysis. For example, it is known to pyrolise HgCl₂ in the presence of nickel as catalyst. A suitable method is described in the German laid-open patent application DE 100 45 212 A1.

A waste gas contaminated with mercury and mercury chloride flows into the converter. On passage through the converter, the mercury is separated from the mercury chloride. After passage through the converter, the waste gas thus only still has elemental mercury.

If an isolated analysis is made of a waste gas passed through a suitable converter, it is thus merely possible to detect which mercury components are present in the waste gas as a whole. In order to also be able to detect in which fractions the mercury is present in the waste gas on the one hand in elemental form and on the other hand in the form of compounds, a so-called difference measuring method is known. In this difference measuring method, before being introduced into the waste gas analysis device, the waste gas is branched into two part waste gas paths (part gas paths) of which respectively only one is passed through a converter. In the case of the gas passed through the converter, the total quantity of mercury present in the waste gas can be determined in the gas analysis device, that is the total mercury in elemental and combined form. In the case of the gas stream not passed through the converter, only the mercury present in elemental form in the waste gas can be determined. By comparing the fractions of mercury determined in each case, it is possible to determine which mercury fractions are present in the waste gas in elemental or combined form.

In order to be able to carry out a corresponding difference measuring method, in the embodiment according to the invention the gas path between at least one aluminium oxide fill and the gas analysis device is branched into two part gas paths along which respectively one partial stream of waste gas can be passed to the gas analysis device. One of these part gas paths can be passed through a converter (see FIG. 1).

A corresponding embodiment is especially suitable for measurement of a waste gas contaminated with high fractions of sulphur oxides since in this case, the waste can be freed of sulphur oxide fractions in the aluminium oxide fill before it enters the converter so that said fractions cannot damage the converter.

According to an alternative embodiment it is provided that the gas path between the gas sampling device and the gas analysis device is branched into two part gas paths which are fed through a respective aluminium oxide fill and along which respectively one partial stream of waste gas can be passed to the gas analysis device. In this embodiment one of the part gas paths between the branching (that is the point at which the gas path is branched into two part gas paths) and the aluminium oxide fill through which it is passed, can be passed through a converter (see FIG. 2).

Such an embodiment is suitable for example for waste gases only slightly contaminated with sulphur oxides; this is because in this case the waste gas, as described previously, is first passed through the converter and only then through the aluminium oxide fill.

The advantage of this last-mentioned embodiment in which waste gas is first passed through the converter and only then through the aluminium oxide fill is especially that in this case, the converter can be arranged directly adjacent to the gas sampling device. A united heating device can thereby be provided for the gas sampling device (in order to heat the waste gas above its dew point) and the converter (to accelerate the conversion of HgCl₂). This saves space and costs.

All the aforesaid features of the waste gas device can be combined singly or in combination respectively arbitrarily with one another.

Further features of the invention are obtained from the dependent claims and the other application documents, especially the drawings.

Two exemplary embodiments of the waste gas measuring device according to the invention are explained in detail with reference to the following highly schematic drawings.

### IN THE FIGURES

FIG. 1 shows a waste gas measuring device in which the aluminium oxide fill is arranged (along the gas path) before the converter and

FIG. 2 shows a waste gas measuring device in which the aluminium oxide fill is arranged (along the gas path) after the converter.

Corresponding components in both figures are respectively provided with the same reference numbers.

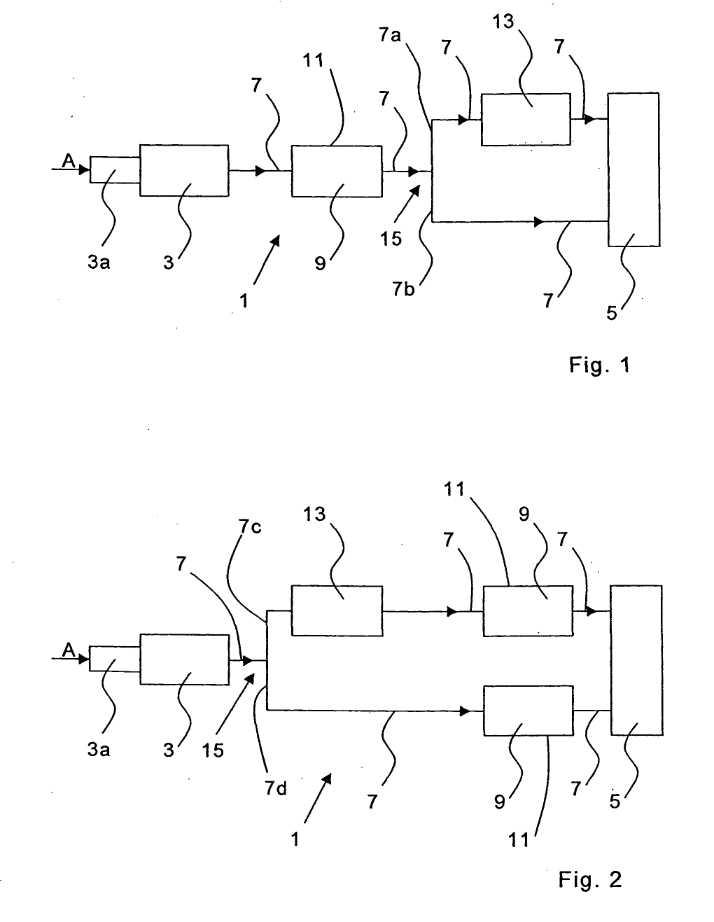

The waste gas measuring device denoted in its entirety with the reference number 1 in FIG. 1 has a gas sampling device 3, a gas analysis device 5 and a plurality of gas guiding members each denoted by 7.

The direction of flow of the waste gas on passage through the waste gas measuring device 1 is respectively denoted by arrows on the gas guiding members 3.

The gas sampling device 3, here in the form of a gas probe, has a gas sampling tube 3a with a pre-filter, here projecting to the left, which can be guided into a waste gas. The waste gas is taken up by the probe 3a, identified here as A, fed into the gas sampling device 3 and from said gas sampling device is passed to an aluminium oxide fill 9 via a first gas guiding member 7.

The gas guiding member 7, like the other gas guiding members 7, consists of a plastic hose.

The aluminium oxide fill 9 is arranged above a retaining member, not shown here, in the form of a perforated plate in a gas-tight plastic housing 11.

After being passed out from the housing 11 and passed on a short distance further via the gas guiding member 7, the gas path defined by this gas guiding member 7 is branched at a branching 15 into two part gas paths 7a and 7b.

Both part gas paths 7a, 7b are again formed by gas guiding members 7.

Whilst the waste gas passed along the part gas path 7b is fed directly into the gas analysis device 5, the waste gas passed along the part gas path 7a is fed via a converter 13 into the gas analysis device 5.

In the converter 13 the HgCl₂ present in the waste gas is converted into Hg(O) and Cl₂ by means of pyrolysis.

In the gas analysis device 5 the part quantities of waste gas passed on the one hand along the part gas path 7a and passed on the other hand along the part gas path 7b into the gas analysis device 5 are analysed and by carrying out a difference measuring method it is established what fraction of mercury, chlorine and mercury compounds are present in the waste gas.

Both the gas analysis device 3 and also the aluminium oxide fill 9 are each assigned a heating device, not shown in FIG. 1, by which the waste gas flowing through the gas sampling device 3 or the aluminium oxide fill 9 can respectively be heated to a temperature of 180° Celsius.

The converter 13 is also provided with a heating device, not shown, by which the conversion can be carried out therein at 650° Celsius.

In the waste gas measuring device according to FIG. 2, the gas sampling device 3, the gas analysis device 5, the gas guiding members 7, the converter 13 and both the aluminium oxide fills 9 respectively arranged in a housing 11 are constructed according to the embodiment in FIG. 1 so that their structure will not be discussed again in detail here.

The detailed structure of the waste gas measuring device according to FIG. 2 is as follows.

The waste gas taken up by the gas sampling device 3 and fed to the waste gas measuring device 1, after passage of the waste gas through the gas sampling device 3, is branched at a branching 15 of the gas path defined by the gas guiding member 7 into two part gas paths 7c, 7d.

The partial quantity of waste gas passed along the part gas path 7d is first passed through an aluminium oxide fill 9 and after passing through this, is fed to the gas analysis device 5.

The partial quantity of waste gas passed along the other part gas path 7c, is first fed through a converter 13, then through an aluminium oxide fill 9 and after passage through this, is also fed to the gas analysis device 5.

The embodiment according to FIG. 1 is especially suitable for waste gases highly contaminated with acidic constituents, as already stated in the description, whilst the embodiment according to FIG. 2 is especially suitable for waste gases weakly contaminated with acidic constituents.

1. A waste gas measuring device comprising
a) a gas sampling device (3),
b) a gas analysis device (5) and
c) at least one gas guiding member (7) through which waste gas can be passed along a gas path from the gas sampling device (3) to the gas analysis device (5),
characterised in that
d) the gas path is passed through at least one aluminium oxide fill (9).

2. The waste gas measuring device according to claim 1, wherein the grain size of the aluminium oxide fill (9) is between 0.5 and 10 mm.

3. The waste gas measuring device according to claim 1, wherein a heating device by which the gas to be passed through the aluminium oxide fill (9) can be heated, is assigned to at least one aluminium oxide fill (9).

4. The waste gas measuring device according to claim 3 with a heating device by which the gas to be passed through the aluminium oxide fill (9) can be heated to a temperature which lies above the dew-point temperature of the gas.

5. The waste gas measuring device according to claim 3 with a heating device by which the gas to be passed through the aluminium oxide fill (9) can be heated to above 100° C.

6. The waste gas measuring device according to claim 1 with at least one gas cooler by which the waste gas can be cooled.

7. The waste gas measuring device according to claim 1, wherein the waste gas can be cooled such that its dew-point temperature lies below 10° C.

8. The waste gas measuring device according to claim 1 wherein the gas path between at least one aluminium oxide fill (9) and the gas analysis device (5) is branched into two part gas paths (7a, 7b) along which respectively one partial stream of the waste gas can be passed to the gas analysis device (5).

9. The waste gas measuring device according to claim 6, wherein one of the part gas paths (7a, 7b) is passed through a converter (13).

10. The waste gas measuring device according to claim 1 wherein the gas path between the gas sampling device (3) and the gas analysis device (5) is branched into two part gas paths (7c, 7d) which are passed through a respective aluminium oxide fill (9) and along which respectively one partial stream of the waste gas can be passed to the gas analysis device (5).

11. The waste gas measuring device according to claim 10 wherein one of the part gas paths (7c, 7d) between the branching (15) and the aluminium oxide fill (9) through which it is passed, is passed through a converter (13).
